(19) United States
(12) Patent Application Publication
(10) Pub. No.: US 2026/0301442 A1
(43) Pub. Date: Oct. 1, 2026

(54) DIATOM MORPHOLOGICAL CLASSIFICATION METHOD FOR INFERRING DROWNING LOCATION IN FORENSIC MEDICINE

(71) Applicant: Academy of Forensic Science, Shanghai (CN)

(72) Inventors: Ji Zhang, Shanghai (CN); Mingzhen Yang, Shanghai (CN); Ping Huang, Shanghai (CN); Yongjie Cao, Xuzhou (CN)

(21) Appl. No.: 19/630,381

(22) Filed: Mar. 26, 2026

(30) Foreign Application Priority Data
Mar. 28, 2025 (CN) 202510382168.1

(51) Int. Cl. G06V 20/69; G06T 7/00; G06T 7/40; G06V 10/77

(52) U.S. Cl. CPC G06V 20/698; G06T 7/0012; G06T 7/40; G06V 10/77; G06T 2207/20036; G06T 2207/30024

(57) ABSTRACT

A diatom morphological classification method for inferring a drowning location in forensic medicine includes: acquiring diatom vector data and tissue vector data; extracting three principal component variables from the diatom vector data and the tissue vector data individually, and representing the three principal component variables as a coordinate point in a three-dimensional space to obtain a first coordinate point and second coordinate points; calculating distances between the first coordinate point and the second coordinate points respectively corresponding to sampling sites; and determining a sampling site corresponding to a second coordinate point with a shortest distance to the first coordinate point as a potential drowning location. Principal component analysis is performed on the tissue vector data and the diatom vector data to obtain the first coordinate point and the second coordinate points, each formed by three principal component variables.

### CROSS-REFERENCE TO RELATED APPLICATION

This application claims priority to Chinese Patent Application No. 202510382168.1, filed on Mar. 28, 2025, which is herein incorporated by reference in its entirety.

### TECHNICAL FIELD

The disclosure relates to the technical field of morphological classification, and more particularly to a diatom morphological classification method for inferring a drowning location in forensic medicine.

### BACKGROUND

In forensic practice, inferring a drowning location is a critical step in clarifying the circumstances of water-related death cases, especially when the location where the submerged body is found is far from the initial drowning site. The inferred drowning location holds significant value in verifying or refuting witness testimonies, accurately estimating the postmortem interval, and uncovering environmental factors that may have contributed to the accident. Furthermore, accurately determining the drowning location makes a notable contribution to public safety efforts, and can help identify high-risk areas for water accidents, providing valuable information to support targeted prevention strategies, such as optimizing the placement of safety signs, strategically positioning lifeguard stations, and conducting comprehensive public education campaigns. By leveraging these insights, relevant authorities can strengthen water safety measures and potentially reduce the number of drowning-related deaths.

Diatoms are unicellular algae characterized by their distinct siliceous cell walls, widely distributed in aquatic environments. During drowning, these microorganisms can be inhaled into the alveolar cavity, subsequently enter the bloodstream via alveolar capillaries, and distribute to organs such as the liver, kidneys, and bone marrow. In some countries, drowning diagnosis heavily relies on detecting diatoms in these organs (particularly the lungs, liver, and kidneys), though the reliability of diatom testing remains debated. Furthermore, forensic experts can infer the drowning location by comparing diatom taxa found in organs with diatom taxa in water samples. Currently, some researchers utilize molecular biology techniques to diagnose drowning and infer the drowning location by identifying diatom species, specifically employing deoxyribonucleic acid (DNA) barcoding technologies such as 16S ribosomal DNA (rDNA), 18S rDNA, and ribulose-1,5-bisphosphate carboxylase/oxygenase large subunit (rbcL). However, these methods are questioned due to the production of non-specific products during polymerase chain reaction (PCR) amplification. Additionally, their widespread application in forensics is hindered by high instrument and labor costs.

In contrast, defining diatom species morphologically provides a more economical alternative, as the specialized equipment required is less costly than molecular techniques, facilitating promotion at the grassroots level of forensic medicine. Morphological identification and classification of the diatoms involve a systematic examination of diatom frustules under high magnification (>1000×), typically using oil immersion lens or electron microscopes. The traditional procedure generally follows these steps: (1) identifying the presence of the diatom frustules; (2) distinguishing key physical features, such as diameter and the orientation of the raphe (centric or eccentric); (3) comparing features including the number of punctate rows, valve length, the diameter and width of striae; and (4) verifying symmetry after initial identification to confirm whether it is bilateral symmetry or radial symmetry. Additional features, such as shape and size, should also be analyzed to further refine the classification. This method requires considerable expertise to discern subtle morphological differences between species and often necessitates consultation with taxonomic atlases and other references to ensure accuracy. It is highly complex, time-consuming, and demands extensive knowledge of aquatic organisms. Particularly in time-sensitive applications like forensic investigations, there is an urgent need to develop faster and more operable diatom classification techniques for the inference of the drowning location in the forensic medicine.

### SUMMARY

The purpose of the disclosure is to provide a diatom morphological classification method for inferring a drowning location in forensic medicine, to achieve fast, accurate, and easily operable drowning location inference.

In order to achieve the above purpose, the following technical solutions are adopted.

The disclosure provides a diatom morphological classification method for inferring a drowning location in forensic medicine, including:
acquiring diatom vector data and tissue vector data;
extracting three principal component variables from the diatom vector data and the tissue vector data individually, and representing the three principal component variables as a coordinate point in a three-dimensional space to obtain a first coordinate point and second coordinate points;
calculating distances between the first coordinate point and the second coordinate points respectively corresponding to sampling sites; and
determining one of the sampling sites corresponding to one of the second coordinate points with a shortest distance to the first coordinate point as a potential drowning location.

In an embodiment, the diatom morphological classification method or inferring a drowning location in forensic medicine further includes: placing warning signs around the potential drowning location to prevent the public from entering hazardous water areas, and arranging lifeguard positions around the potential drowning location to shorten rescue response time and thereby enhance rescue efficiency in case of emergencies, helping to reduce the occurrence of drowning.

In an embodiment, the acquiring diatom vector data and tissue vector data includes:
collecting water samples from the sampling sites in a target area, and preparing water sample smears from the water samples;
counting a diatom quantity in each of the water sample smears of the sampling sites;
classifying diatoms in the water sample smears by a diatom classification system, and calculating percentages of respective diatom types relative to the diatom quantity in each of the water sample smears;
arranging values of the percentages of respective diatom types in a predetermined order to obtain the diatom vector data for each of the sampling sites; and
extracting a human tissue sample to be tested, preparing a tissue smear from the human tissue sample, and classifying diatoms in the tissue smear by the diatom classification system to obtain the tissue vector data.

In an embodiment, the diatom quantity in each of the water sample smears of the sampling sites is not less than 500.

In an embodiment, a process for classifying the diatoms in the water sample smears or the tissue smear by the diatom classification system includes:
extracting a diatom frustule feature, an outline feature, and a texture feature for the diatoms from the water sample smears or the tissue smear;
determining, based on the diatom frustule feature, symmetry classification of the diatoms from the water sample smears or the tissue smear;
determining, based on the outline feature, outline classification of the diatoms from the water sample smears or the tissue smear; and
determining, based on the texture feature, texture classification of the diatoms from the water sample smears or the tissue smear.

In an embodiment, the process for classifying the diatoms in the water sample smears or the tissue smear by the diatom classification system further includes:
representing the symmetry classification, the outline classification, and the texture classification as a three-dimensional variable, where the three-dimensional variable includes three variable values, and the three variable values respectively represent classification numbers of the symmetry classification, the outline classification and the texture classification.

In an embodiment, the determining, based on the diatom frustule feature, symmetry classification of the diatoms from the water sample smears or the tissue smear includes:
determining, in response to the diatom frustule feature being that a diatom frustule rotates around a central point at any angle while maintaining a shape and appearance of the diatom frustule unchanged, the symmetry classification as radial symmetry;
determining, in response to the diatom frustule feature being that the diatom frustule exhibits symmetry on an apical axis and a transapical axis, thereby causing the shape and appearance of the diatom frustule to remain unchanged when rotated at a specific angle less than 360 degrees, the symmetry classification as double-axis symmetry;
determining, in response to the diatom frustule feature being that the diatom frustule has inverted portions aligned along the apical axis or the transapical axis, thereby causing the shape and appearance of the diatom frustule to remain unchanged when rotated at an angle less than 360 degrees, the symmetry classification as inversion symmetry;
determining, in response to the diatom frustule feature being that the diatom frustule exhibits symmetry on only one of the apical axis or the transapical axis, thereby causing the shape and appearance of the diatom frustule to remain unchanged when rotated at an angle less than 360 degrees, the symmetry classification as single-axis symmetry;
determining, in response to the diatom frustule feature being that the diatom frustule is asymmetric on the apical axis and the transapical axis, thereby causing the shape and appearance of the diatom frustule to be changed when rotated at any angle less than 360 degrees, the symmetry classification as asymmetry.

In an embodiment, the determining, based on the outline feature, outline classification of the diatoms from the water sample smears or the tissue smear includes:
determining, in response to the outline feature being a two-dimensional circular figure in which all points are equidistant from a center, the outline classification as circular;
determining, in response to the outline feature being a two-dimensional elliptical curve in which a sum of distances from any point on the two-dimensional elliptical curve to two target points remains constant, the outline classification as elliptical;
determining, in response to the outline feature being an elongated symmetrical shape with two gradually tapering ends and bulging sides, the outline classification as spindle-shaped;
determining, in response to the outline feature being an elongated shape with two gradually pointed ends and relatively straight sides, the outline classification as needle-shaped;
determining, in response to the outline feature being an elongated, straight rectangle with two flat ends, the outline classification as rod-shaped;
determining, in response to the outline feature being a smooth, flowing line or shape without sharp angles, which is open or closed and gradually changes direction, the outline classification as curve-shaped;
determining, in response to the outline feature being a two-dimensional shape with four sides and four right angles, the outline classification as square;
determining, in response to the outline feature being an elongated, extended shape with two pointed ends, the outline classification as willow-leaf-shaped;
determining, in response to the outline feature being a boat-like shape characterized by an elongated, curved structure, wider in a middle and gradually tapering toward two ends, the outline classification as navicular;
determining, in response to the outline feature being an elongated shape in which two rounded, swollen ends are connected by a narrower middle part, the outline classification as peanut-shaped;
determining, in response to the outline feature being a symmetrical shape with a circular or elliptical center and two twisted ends, the outline classification as candy-shaped;
determining, in response to the outline feature being a smooth teardrop shape with a rounded bottom and a gradually tapering top, the outline classification as drop-shaped;
determining, in response to the outline feature being a shape composed of two parallel, elongated, equal-length rods of uniform width, the outline classification as double-bar-shaped;
determining, in response to the outline feature being a sharp triangular contour with a base gradually narrowing to a sharp apex and a distinct protrusion at the base, the outline classification as dart-shaped.

In an embodiment, the determining, based on the texture feature, texture classification of the diatoms from the water sample smears or the tissue smear includes:
determining, in response to the texture feature being absence of any texture, the texture classification as empty texture;
determining, in response to the texture feature being a pattern with equal, short, fence-like structures which are along an edge and located on an inner side or an outer side, the texture classification as serrated texture;
determining, in response to the texture feature being a pattern with straight, uniform lines running through an entire body at equal intervals, forming a striped or linear appearance, the texture classification as striped texture;
determining, in response to the texture feature being a pattern with a prominent single vertical line running from top to bottom through an entire body, located in a central position, the texture classification as vertical line texture;
determining, in response to the texture feature being a pattern defined by intersecting a vertical line and a horizontal line that meet at a right angle, forming a symmetrical cross shape, the texture classification as cross-shaped texture;
determining, in response to the texture feature being a pattern defined by uniformly distributed horizontal lines intersecting a single vertical line running through from top to bottom, the texture classification as fence-like texture;
determining, in response to the texture feature being a pattern composed of two concentric circles, with an edge of each of the two concentric circles decorated with radial patterns, the texture classification as concentric circle texture.

In an embodiment, the extracting three principal component variables from the diatom vector data and the tissue vector data individually includes:
extracting, based on principal component analysis (PCA), first three principal component variables from the diatom vector data and the tissue vector data individually.

In an embodiment, the calculating distances between the first coordinate point and the second coordinate points respectively corresponding to sampling sites includes:
calculating cosine distances or Euclidean distances between the first coordinate point and the second coordinate points respectively corresponding to the sampling sites.

The disclosure has the following beneficial effects.

The disclosure utilizes the diatom classification system to classify the diatoms in the tissue smear and the water sample smears collected from various sampling sites, to thereby obtain the tissue vector data and the diatom vector data. The PCA is performed on the tissue vector data and the diatom vector data to obtain the first coordinate point and the second coordinate points, each formed by the three principal component variables. Based on the distances between the first coordinate point and respective second coordinate points, the sampling site corresponding to the second coordinate point with the shortest distance is determined as the potential drowning location. Through the above approach, the disclosure enables rapid, accurate, and easily operable inference of the drowning location.

### BRIEF DESCRIPTION OF DRAWINGS

FIG. 1 illustrates a flowchart of a diatom morphological classification method for inferring a drowning location in forensic medicine according to an embodiment of the disclosure.

FIG. 2 illustrates a flowchart of classification of diatoms in water sample smears or a tissue sample using a diatom classification system according the embodiment of to the disclosure.

FIG. 3 illustrates a schematic diagram of symmetry classification according to the embodiment of the disclosure.

FIG. 4 illustrates a schematic diagram of outline classification according to the embodiment of the disclosure.

FIG. 5 illustrates a schematic diagram of texture classification according to the embodiment of the disclosure.

FIGS. 6A-6D illustrate effect diagrams of the diatom morphological classification method for inferring a drowning location in forensic medicine according to the disclosure. FIG. 6A illustrates a PCA scatter plot of in vitro experiments; FIG. 6B illustrates a PCA scatter plot of in vivo experiments; FIG. 6C illustrates a confusion matrix for drowning location inference in in vitro experiments; and FIG. 6D illustrates a confusion matrix for drowning location inference in in vitro experiments.

### DETAILED DESCRIPTION OF EMBODIMENTS

The following describes the implementation of the disclosure through specific examples. Those skilled in the art can readily understand other advantages and efficacies of the disclosure from the content disclosed in this specification. The disclosure may also be implemented or applied through other different specific embodiments. Various details in this specification may be modified or changed based on different perspectives and applications without departing from the spirit of the disclosure. It should be noted that, provided there is no conflict, the following embodiments and the features therein may be combined with each other.

Combined with the accompanying drawings and embodiments, a further detailed description of the specific implementation methods of the disclosure will be provided below.

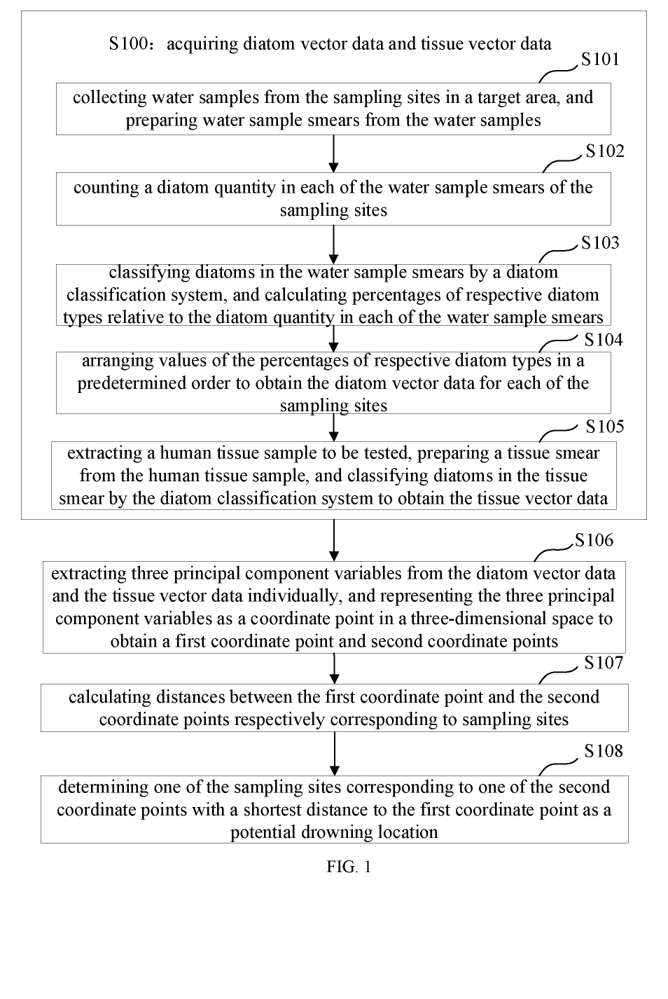

FIG. 1 illustrates a flowchart of a diatom morphological classification method for inferring a drowning location in forensic medicine according to an embodiment of the disclosure. An embodiment of the disclosure provides a diatom morphological classification method for inferring a drowning location in forensic medicine. The diatom morphological classification method includes the following steps S100-S108.

S100, diatom vector data and tissue vector data are acquired.

In some embodiments, step S100 includes the following steps S101-S105.

S101, water samples are collected from multiple sampling sites in a target area, and water sample smears are prepared from the water samples.

S102, a diatom quantity in each of the water sample smears of the sampling sites is counted.

S103, diatoms in the water sample smears are classified by a diatom classification system, and percentages of respective diatom types relative to the diatom quantity in each of the water sample smear are calculated.

S104, values of the percentages of respective diatom types are arranged in a predetermined order to obtain the diatom vector data for each of the sampling sites.

S105, a human tissue sample to be tested is extracted, a tissue smear is prepared from the human tissue sample, and diatoms in the tissue smear are classified by the diatom classification system to obtain tissue vector data.

S106, three principal component variables are extracted from the diatom vector data and the tissue vector data individually, and the three principal component variables are represented as a coordinate point in a three-dimensional space to obtain a first coordinate point and second coordinate points.

S107, distances between the first coordinate point and the second coordinate points respectively corresponding to the sampling sites are calculated.

S108, one of the sampling sites corresponding to one of the second coordinate points with a shortest distance to the first coordinate point is determined as a potential drowning location.

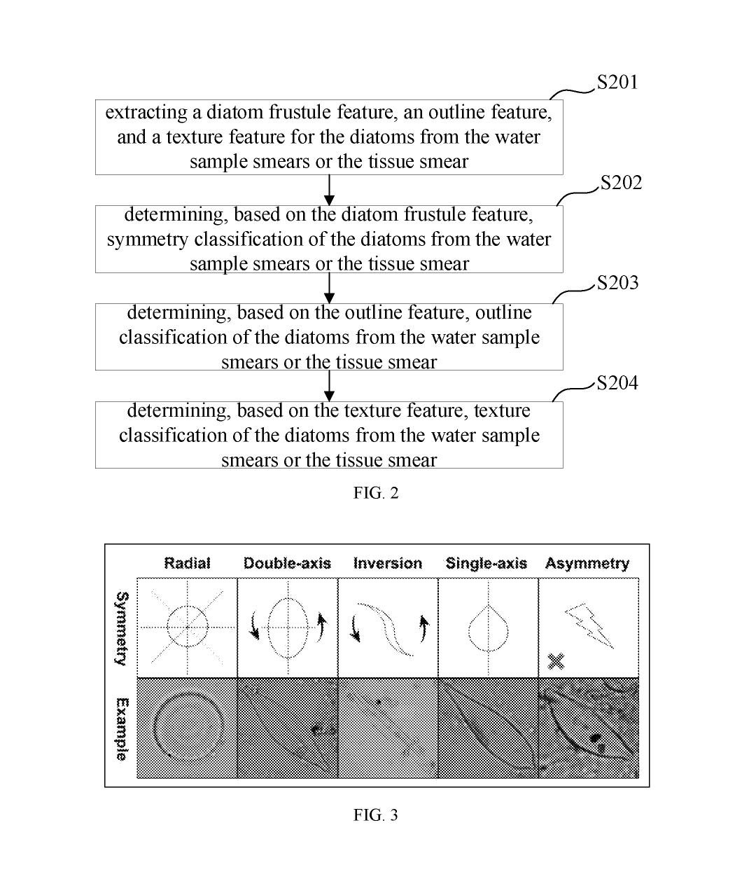

In some embodiments, as shown in FIG. 2, a process for classifying the diatoms in the water sample smears or the tissue smear by the diatom classification system includes the following steps S201-S204.

S201, a diatom frustule feature, an outline feature, and a texture feature for the diatoms from the water sample smears or the tissue smear are extracted;

S202, based on the diatom frustule feature, symmetry classification of the diatoms from the water sample smears or the tissue smear is determined.

S203, based on the outline feature, outline classification of the diatoms from the water sample smears or the tissue smear is determined.

S204, based on the texture feature, texture classification of the diatoms from the water sample smears or the tissue smear is determined.

In this embodiment, the diatom classification system may achieve the diatom classification in human tissue and water sample smears under conventional microscopy at magnifications up to 400×. The diatom classification system identifies the diatoms by extracting the frustule feature, the contour feature, and the texture feature from the smears. Each type of the diatom can be defined by a three-dimensional vector, for example, a three-dimensional vector denoted as (a, b, c), where a, b, and c are vector values representing classification numbers for the symmetry classification, the contour classification and the texture classification of the diatom, respectively.

Specifically, as shown in FIG. 3, regarding the symmetry classification, it is divided into five types, and the corresponding symmetry classification number a can be any natural number from 1 to 5, as detailed below.
1) The symmetry classification is determined as radial symmetry: a diatom frustule rotates around a central point at any angle while maintaining a shape and appearance of the diatom frustule unchanged.
2) The symmetry classification is determined as double-axis symmetry: the diatom frustule exhibits symmetry on an apical axis and a transapical axis, thereby causing the shape and appearance of the diatom frustule to remain unchanged when rotated at a specific angle less than 360 degrees.
3) The symmetry classification is determined as inversion symmetry: the diatom frustule has inverted portions aligned along the apical axis or the transapical axis, thereby causing the shape and appearance of the diatom frustule to remain unchanged when rotated at a specific angle less than 360 degrees.
4) The symmetry classification is determined as single-axis symmetry: the diatom frustule exhibits symmetry on only one of the apical axis or the transapical axis, thereby causing the shape and appearance of the diatom frustule to remain unchanged when rotated at a specific angle less than 360 degrees.
5) The symmetry classification is determined as asymmetry: the diatom frustule is asymmetric on the apical axis and the transapical axis, thereby causing the shape and appearance of the diatom frustule to be changed when rotated at any angle less than 360 degrees.

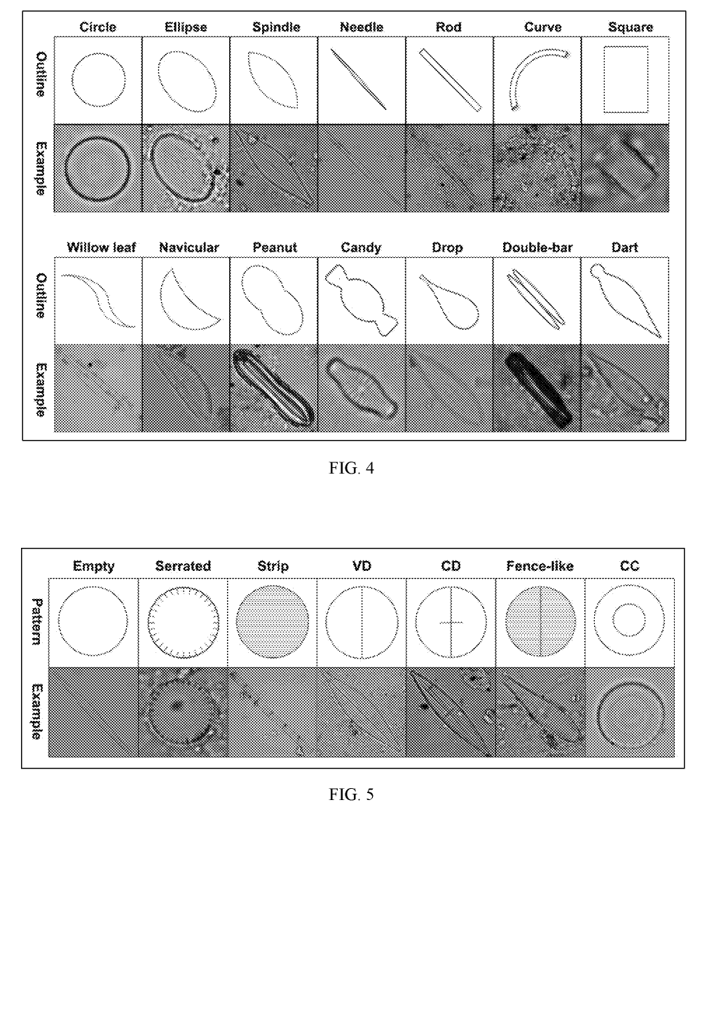

As shown in FIG. 4, regarding outline classification, it is mainly divided into 14 types, and the corresponding outline classification number b is any natural number from 1 to 14, specifically as follows.
1) The outline classification is determined as circular: the outline feature is a two-dimensional circular figure in which all points are equidistant from a center.
2) The outline classification is determined as elliptical: the outline feature is a two-dimensional elliptical curve in which a sum of distances from any point on the two-dimensional elliptical curve to two target points remains constant.
3) The outline classification is determined as spindle-shaped: the outline feature is an elongated symmetrical shape with two gradually tapering ends and bulging sides.
4) The outline classification is determined as needle-shaped: the outline feature is an elongated shape with two gradually pointed ends and relatively straight sides.
5) The outline classification is determined as rod-shaped: the outline feature is an elongated, straight rectangle with two flat ends.
6) The outline classification is determined as curve-shaped: the outline feature is a smooth, flowing line or shape without sharp angles, which is open or closed and may gradually change direction.
7) The outline classification is determined as square: the outline feature is a two-dimensional shape with four sides and four right angles.
8) The outline classification is determined as willow-leaf-shaped: the outline feature is an elongated, extended shape with two pointed ends, resembling a willow leaf, and often slightly curved like the letter ‘S’.
9) The outline classification is determined as navicular: the outline feature is a boat-like shape characterized by an elongated, curved structure, wider in a middle and gradually tapering toward two ends.
10) The outline classification is determined as peanut-shaped: the outline feature is an elongated shape in which two rounded, swollen ends are connected by a narrower middle part, resembling the shape of the number ‘8’.
11) The outline classification is determined as candy-shaped: the outline feature is a small, symmetrical shape with a circular or elliptical center and two twisted ends, resembling a wrapped candy.
12) The outline classification is determined as drop-shaped: the outline feature is a smooth teardrop shape with a rounded bottom and a gradually tapering top.
13) The outline classification is determined as double-bar-shaped: the outline feature is a shape composed of two parallel, elongated, equal-length rods of uniform width.
14) The outline classification is determined as dart-shaped: the outline feature is a shape resembling a Chinese dart, having a sharp triangular contour with a broad base gradually narrowing to a sharp apex and a distinct protrusion at the base.

As shown in FIG. 5, VD represents vertical line texture, CD represents cross-shaped texture, and CC represents concentric circle texture. Regarding texture classification, it is mainly divided into 7 types, and the corresponding texture classification number c is any natural number from 1 to 7, specifically as follows.
1) The texture classification as is determined as empty texture: the texture feature is absence of any texture.
2) The texture classification as is determined as serrated texture: the texture feature is a pattern with equal, short, fence-like structures which are along an edge and located on an inner side or an outer side.
3) The texture classification as is determined as striped texture: the texture feature is a pattern with straight, uniform lines running through an entire body at equal intervals, forming a striped or linear appearance.
4) The texture classification as is determined as vertical line texture: the texture feature is a pattern with a prominent single vertical line running from top to bottom through an entire body, located in a central position.
5) The texture classification as is determined as cross-shaped texture: the texture feature is a pattern defined by intersecting a vertical line and a horizontal line that meet at a right angle, forming a symmetrical cross shape, such as “+”.
6) The texture classification as is determined as fence-like texture: the texture feature is a pattern defined by uniformly distributed horizontal lines intersecting a single vertical line running through from top to bottom.
7) The texture classification as is determined as concentric circle texture: the texture feature is a pattern composed of two concentric circles, with an edge of each of the two concentric circles decorated with radial patterns.

In an embodiment, a diatom water sample database for a target area can be constructed through steps S101-104 in the process as shown in FIG. 1, and drowning location inference can be achieved by the following steps (1)-(4).
(1) A human tissue sample to be tested is extracted and prepared into a smear, and the tissue vector data is formed by using a diatom classification system.
(2) Analysis is performed on the database and the human tissue vector data respectively using PCA, and the first three principal component variables are extracted. The first three principal component variable values can be represented as a coordinate point (x, y, z) in a three-dimensional space.
(3) The distance between the coordinate point formed by the three principal component values of the human tissue sample to be tested and the coordinate point formed by the three principal component values of each water sampling site in the database is calculated.
(4) The water sample sampling site with the shortest distance to the human tissue sample to be tested is determined as the potential drowning location.

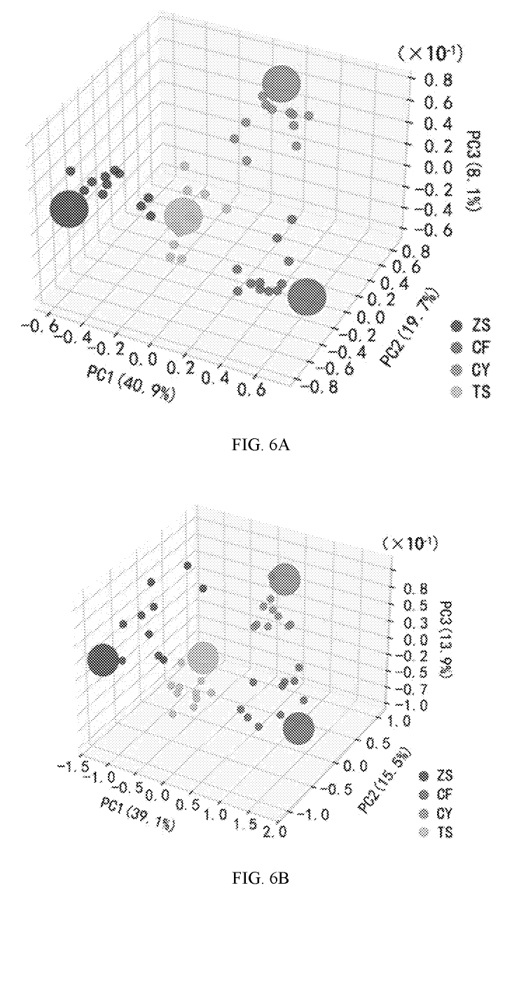

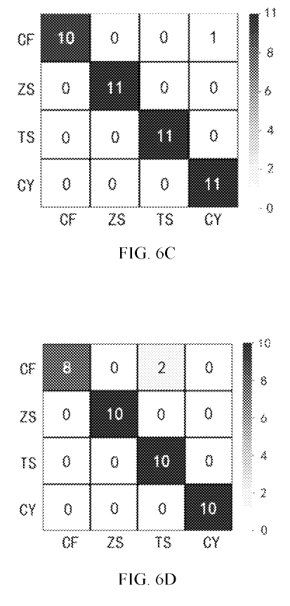

The final result is shown in FIGS. 6A-6D.

FIGS. 6A-6B illustrate three-dimensional scatter plots generated by performing PCA on the diatom abundance data from four sampling sites (CF, ZS, CY, and TS), revealing the diatom community characteristics of different water bodies. In these plots, the large points represent the centroids of the reference water sample data, while the small points correspond to samples from in vitro and in vivo experiments. The PCA results show that diatom communities from different sampling sites form clear and distinct clusters, indicating that the water source exerts a significant influence on the diatom community, thus making the diatom community an effective marker for forensic water body identification. For example, samples from the sampling site CY form a tight and independent cluster, demonstrating that its unique diatom composition can distinguish the sampling site CY from the other sampling sites (CF, ZS, and TS), including samples from both in vitro and in vivo experiments.

Furthermore, the centroid of each cluster (large point) serves as a central reference point, facilitating distance-based classification analysis. Specifically, these centroids can be used to calculate the Mahalanobis distance, thereby assigning unknown sample to the most probable drowning location. By comparing the distance from each unknown sample to the nearest centroid in in vitro and in vivo experiments, the samples can be confidently linked to their corresponding water sources. Based on Mahalanobis distance calculations, both in vitro and in vivo experiments demonstrated high classification accuracy in drowning location identification. Specifically, the in vitro experiment (n = 44) achieved a classification accuracy of 0.98, indicating that nearly all samples were correctly assigned to their respective water bodies. In comparison, the in vivo experiment (n = 40) showed slightly lower accuracy, at 0.95. Additionally, FIGS. 6C-6D present the confusion matrices for the classification results of the in vitro and in vivo experiments, showing high classification accuracy for three sampling sites (CY, ZS, and TS), where all samples were correctly classified. However, minor misclassifications occurred for the sampling site CF in both confusion matrices: in the in vitro experiment (FIG. 6C), one CF sample was misclassified as CY; whereas in the in vivo experiment (FIG. 6D), two CF samples were misclassified as TS.

The above embodiments are only used to illustrate the disclosure and not to limit it. Those skilled in the art may make various changes and modifications without departing from the spirit and scope of the disclosure. Therefore, all equivalent technical solutions also belong to the scope of the disclosure, and the scope of patent protection of the disclosure should be limited by the claims.

What is claimed is:

1. A diatom morphological classification method for inferring a drowning location in forensic medicine, comprising:
acquiring diatom vector data and tissue vector data;
extracting three principal component variables from the diatom vector data and the tissue vector data individually, and representing the three principal component variables as a coordinate point in a three-dimensional space to obtain a first coordinate point and second coordinate points;
calculating distances between the first coordinate point and the second coordinate points respectively corresponding to sampling sites; and
determining one of the sampling sites corresponding to one of the second coordinate points with a shortest distance to the first coordinate point as a potential drowning location;
wherein the acquiring diatom vector data and tissue vector data comprises:
collecting water samples from the sampling sites in a target area, and preparing water sample smears from the water samples;
counting a diatom quantity in each of the water sample smears of the sampling sites;
classifying diatoms in the water sample smears by a diatom classification system, and calculating percentages of respective diatom types relative to the diatom quantity in each of the water sample smears;
arranging values of the percentages of respective diatom types in a predetermined order to obtain the diatom vector data for each of the sampling sites; and
extracting a human tissue sample to be tested, preparing a tissue smear from the human tissue sample, and classifying diatoms in the tissue smear by the diatom classification system to obtain the tissue vector data;
wherein a process for classifying the diatoms in the water sample smears or the tissue smear by the diatom classification system comprises:
extracting a diatom frustule feature, an outline feature, and a texture feature for the diatoms from the water sample smears or the tissue smear;
determining, based on the diatom frustule feature, symmetry classification of the diatoms from the water sample smears or the tissue smear;
determining, based on the outline feature, outline classification of the diatoms from the water sample smears or the tissue smear; and
determining, based on the texture feature, texture classification of the diatoms from the water sample smears or the tissue smear.

2. The diatom morphological classification method for inferring a drowning location in forensic medicine as claimed in claim 1, wherein the diatom quantity in each of the water sample smears of the sampling sites is not less than 500.

3. The diatom morphological classification method for inferring a drowning location in forensic medicine as claimed in claim 1, wherein the process for classifying the diatoms in the water sample smears or the tissue smear by the diatom classification system further comprises:
representing the symmetry classification, the outline classification, and the texture classification as a three-dimensional variable, wherein the three-dimensional variable comprises three variable values, and the three variable values respectively represent classification numbers of the symmetry classification, the outline classification and the texture classification.

4. The diatom morphological classification method for inferring a drowning location in forensic medicine as claimed in claim 1, wherein the determining, based on the diatom frustule feature, symmetry classification of the diatoms from the water sample smears or the tissue smear comprises:
determining, in response to the diatom frustule feature being that a diatom frustule rotates around a central point at any angle while maintaining a shape and appearance of the diatom frustule unchanged, the symmetry classification as radial symmetry;
determining, in response to the diatom frustule feature being that the diatom frustule exhibits symmetry on an apical axis and a transapical axis, thereby causing the shape and appearance of the diatom frustule to remain unchanged when rotated at a specific angle less than 360 degrees, the symmetry classification as double-axis symmetry;
determining, in response to the diatom frustule feature being that the diatom frustule has inverted portions aligned along the apical axis or the transapical axis, thereby causing the shape and appearance of the diatom frustule to remain unchanged when rotated at an angle less than 360 degrees, the symmetry classification as inversion symmetry;
determining, in response to the diatom frustule feature being that the diatom frustule exhibits symmetry on only one of the apical axis or the transapical axis, thereby causing the shape and appearance of the diatom frustule to remain unchanged when rotated at an angle less than 360 degrees, the symmetry classification as single-axis symmetry;
determining, in response to the diatom frustule feature being that the diatom frustule is asymmetric on the apical axis and the transapical axis, thereby causing the shape and appearance of the diatom frustule to be changed when rotated at any angle less than 360 degrees, the symmetry classification as asymmetry.

5. The diatom morphological classification method for inferring a drowning location in forensic medicine as claimed in claim 1, wherein the determining, based on the outline feature, outline classification of the diatoms from the water sample smears or the tissue smear comprises:
determining, in response to the outline feature being a two-dimensional circular figure in which all points are equidistant from a center, the outline classification as circular;
determining, in response to the outline feature being a two-dimensional elliptical curve in which a sum of distances from any point on the two-dimensional elliptical curve to two target points remains constant, the outline classification as elliptical;
determining, in response to the outline feature being an elongated symmetrical shape with two gradually tapering ends and bulging sides, the outline classification as spindle-shaped;
determining, in response to the outline feature being an elongated shape with two gradually pointed ends and relatively straight sides, the outline classification as needle-shaped;
determining, in response to the outline feature being an elongated, straight rectangle with two flat ends, the outline classification as rod-shaped;
determining, in response to the outline feature being a smooth, flowing line or shape without sharp angles, which is open or closed and gradually changes direction, the outline classification as curve-shaped;
determining, in response to the outline feature being a two-dimensional shape with four sides and four right angles, the outline classification as square;
determining, in response to the outline feature being an elongated, extended shape with two pointed ends, the outline classification as willow-leaf-shaped;
determining, in response to the outline feature being a boat-like shape characterized by an elongated, curved structure, wider in a middle and gradually tapering toward two ends, the outline classification as navicular;
determining, in response to the outline feature being an elongated shape in which two rounded, swollen ends are connected by a narrower middle part, the outline classification as peanut-shaped;
determining, in response to the outline feature being a symmetrical shape with a circular or elliptical center and two twisted ends, the outline classification as candy-shaped;
determining, in response to the outline feature being a smooth teardrop shape with a rounded bottom and a gradually tapering top, the outline classification as drop-shaped;
determining, in response to the outline feature being a shape composed of two parallel, elongated, equal-length rods of uniform width, the outline classification as double-bar-shaped;
determining, in response to the outline feature being a sharp triangular contour with a base gradually narrowing to a sharp apex and a distinct protrusion at the base, the outline classification as dart-shaped.

6. The diatom morphological classification method for inferring a drowning location in forensic medicine as claimed in claim 1, wherein the determining, based on the texture feature, texture classification of the diatoms from the water sample smears or the tissue smear comprises:
determining, in response to the texture feature being absence of any texture, the texture classification as empty texture;
determining, in response to the texture feature being a pattern with equal, short, fence-like structures which are along an edge and located on an inner side or an outer side, the texture classification as serrated texture;
determining, in response to the texture feature being a pattern with straight, uniform lines running through an entire body at equal intervals, forming a striped or linear appearance, the texture classification as striped texture;
determining, in response to the texture feature being a pattern with straight, uniform lines running through the entire body at equal intervals, forming a striped or linear appearance, the texture classification as vertical line texture;
determining, in response to the texture feature being a pattern with a prominent single vertical line running from top to bottom through an entire body, located in a central position, the texture classification as cross-shaped texture;
determining, in response to the texture feature being a pattern defined by uniformly distributed horizontal lines intersecting a single vertical line running through from top to bottom, the texture classification as fence-like texture;
determining, in response to the texture feature being a pattern composed of two concentric circles, with an edge of each of the two concentric circles decorated with radial patterns, the texture classification as concentric circle texture.

7. The diatom morphological classification method for inferring a drowning location in forensic medicine as claimed in claim 1, wherein the extracting three principal component variables from the diatom vector data and the tissue vector data individually comprises:
extracting, based on principal component analysis, first three principal component variables from the diatom vector data and the tissue vector data individually.

8. The diatom morphological classification method for inferring a drowning location in forensic medicine as claimed in claim 1, wherein the calculating distances between the first coordinate point and the second coordinate points respectively corresponding to sampling sites comprises:
calculating cosine distances or Euclidean distances between the first coordinate point and the second coordinate points respectively corresponding to the sampling sites.
